(19) United States
(12) Patent Application Publication
(10) Pub. No.: US 2017/0124258 A1
(43) Pub. Date: May 4, 2017

(54) Dynamic De-Identification of Healthcare Data

(71) Applicant: MModal IP LLC, Franklin, TN (US)

(72) Inventors: Juergen Fritsch, Pittsburgh, PA (US); Vasudevan Jagannathan, Morgantown, WV (US); Thomas Polzin, Pittsburgh, PA (US); Henry W. Ware, Morgantown, WV (US)

(73) Assignee: MModal IP LLC, Franklin, TN (US)

(21) Appl. No.: 14/932,266

(22) Filed: Nov. 4, 2015

(51) Int. Cl. G06F 19/00; G06F 17/30; G06F 21/62; H04L 29/06

(52) U.S. Cl. CPC G06F 19/322; H04L 63/105; G06F 17/30867; G06F 17/30011; G06F 21/6254

(57) ABSTRACT

A method for dynamic de-identification of a document includes generating a document including a tag associated with an element including protected health information, the tag including at least one instruction for rendering the element. The method includes identifying a level of authorization of a user requesting access to the generated document. The method includes rendering the document for display to the user according to the at least one instruction in the tag, based on the determined level of authorization.

### BACKGROUND

In the healthcare industry, there is a wide variety of private data about patients that is known as Protected Health Information (PHI). Such information includes the names and other personally identifying information about patients, and any information that can link individual patients to diagnoses, medications, and other individual information. PHI must be handled confidentially under U.S. law, such as the Health Insurance Portability and Accountability Act (HIPAA). If an entity obtains PHI in an authorized manner, that entity can only disclose the PHI to third parties in ways that are permitted by HIPAA. For example, if a company that transcribes a dictated report from a physician about a particular patient produces a transcript that contain PHI about that patient, such a company can provide the transcript back to the physician and to other healthcare professionals who provide healthcare services to the patient, but the company cannot provide the transcript to medical researchers or professors because the transcript contains PHI.

One problem created by this situation results from the fact that documents, such as transcripts of physician reports, which contain PHI are often very useful for performing medical research. For example, analyzing a large number of transcripts relating to patients who have received cancer surgery may reveal trends that could help to improve such surgery in the future. However, due to the privacy limitations imposed by HIPAA, such transcripts cannot be provided to medical researchers. In the prior art, this problem is addressed by making a copy of transcripts and other documents containing PHI, and stripping any PHI from such documents. This process of stripping PHI from documents is referred to as “anonymizing” or “de-identifying” the documents.

The primary disadvantage of such prior art techniques for de-identifying documents is that they result in two sets of data: the original data, and the de-identified data. Creating and maintaining such duplicate sets of data creates the need for significant extra amounts of storage and also complicates the process of searching, analyzing, and processing the data more generally.

### SUMMARY

In one aspect, a method for dynamic de-identification of a document includes generating a document including a tag associated with an element including protected health information, the tag including at least one instruction for rendering the element. The method includes identifying a level of authorization of a user requesting access to the generated document. The method includes rendering the document for display to the user according to the at least one instruction in the tag, based on the identified level of authorization.

In another aspect, a method for searching elements of a document including at least one dynamically de-identified element. The method includes generating a document including a first element and a second element, the first element associated with a first tag indicating the first element includes protected health information (PHI). The method includes receiving a query. The method includes excluding the first element from a search for elements satisfying the query, based upon the first tag. The method includes including the second element in the search. The method includes executing the search for elements satisfying the query by analyzing one or more elements including the second element and excluding the first element.

In still another aspect, a method for querying a plurality of documents including at least one dynamically de-identified document includes generating a first document including a first element associated with a first tag indicating the first element includes protected health information (PHI). The method includes generating a second document including a second element. The method includes receiving a query. The method includes excluding the first element from a search for elements satisfying the query, based upon the first tag. The method includes including the second element in the search. The method includes executing the search for elements satisfying the query by analyzing one or more elements including the second element and excluding the first element.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting one embodiment of a system for dynamic de-identification of a document;

FIG. 1B is a block diagram depicting one embodiment of a system for dynamic de-identification of a document, the system including a transcription system;

FIG. 1C is a block diagram depicting one embodiment of a tagged transcript in a system for dynamic de-identification of a document;

FIG. 1D is a block diagram depicting one embodiment of a tagged transcript and associated renderings of the tagged transcript in a system for dynamic de-identification of a document;

FIG. 2 is a flow diagram depicting one embodiment of a method for dynamic de-identification of a document;

FIG. 3A is a flow diagram depicting one embodiment of a method for searching elements of a document including at least one dynamically de-identified element;

FIG. 3B is a flow diagram depicting one embodiment of a method for querying a plurality of documents including at least one dynamically de-identified document; and

FIG. 4 is a flow diagram depicting one embodiment of a method for querying a plurality of documents including at least one dynamically de-identified document.

### DETAILED DESCRIPTION

Methods and systems for dynamic de-identification of documents provide functionality for enabling a set of documents to be used by a plurality of entities, even in circumstances in which protected health information (PHI) is not permitted to be provided to some of the entities. By way of example, if a user who lacks authority to view the PHI in a particular document makes a request to view that document, the methods and systems described herein may provide functionality that removes the PHI from the document in the process of providing (e.g., displaying) the document to the requesting user. As a result, the original document in the dataset need not be changed or duplicated. Furthermore, the methods and systems described herein may provide functionality for de-identifying a document without making a copy of the document. This technique may be referred to as “dynamic de-identification” because the functionality performs the de-identification dynamically, i.e., on-the-fly in response to a request from a user for a particular document, rather than ahead of time before the document is requested. The methods and systems described herein, and as will be described in further detail below, facilitate the dynamic de-identification of documents by storing special data in each document when the document is created.

Although the methods and systems described herein describe the de-identification of documents containing PHI, it should be understood that these methods and systems might also be applied to documents containing any type of data that a user may wish to obfuscate, or for which some users should receive one rendering of data while other users should receive a second, different rendering of the same data, where the document itself indicates how to perform the alternative rendering of the data. As one example, frequently, patients with psychiatric problems require higher level of content protection. In such an example, it is quite likely that the PHI itself (e.g., name and medical record number) is not protected, but a specific set of conditions are excluded or redacted from the presentation.

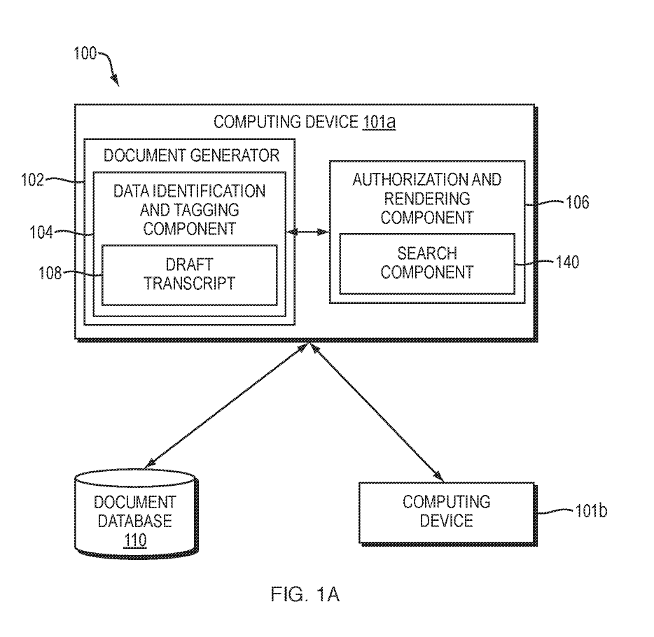

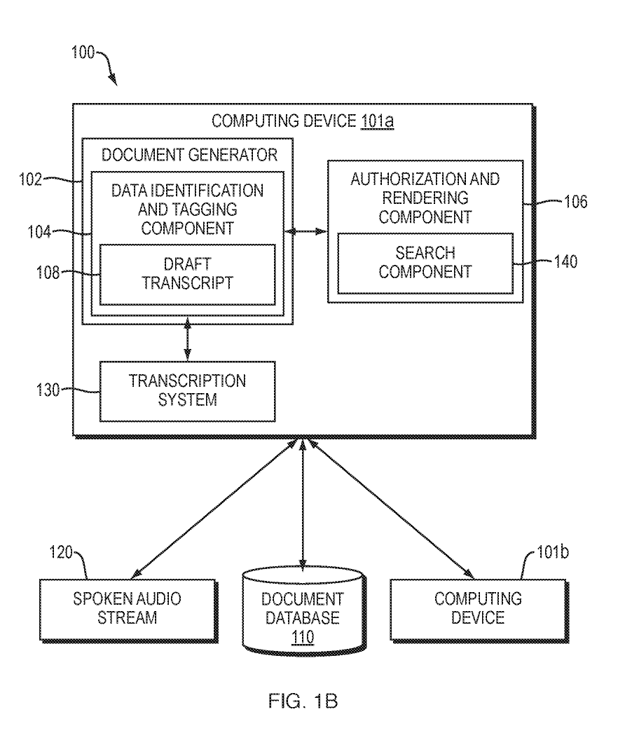

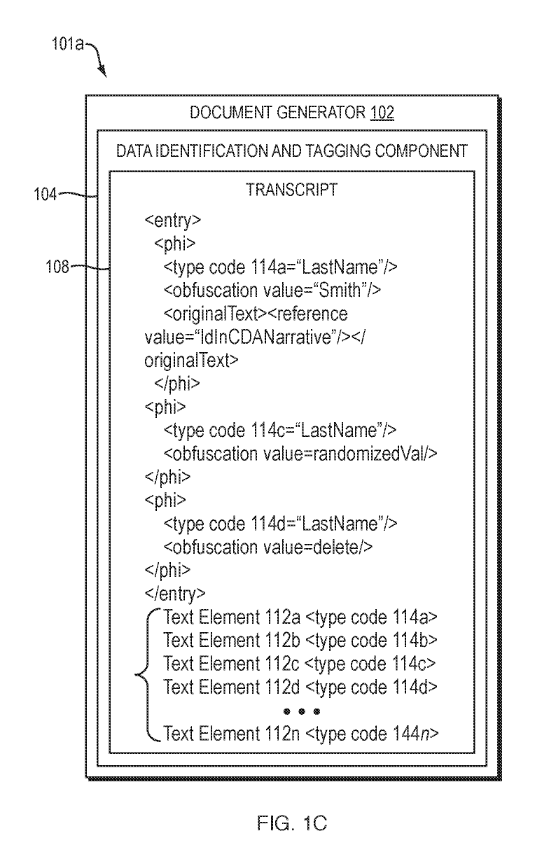

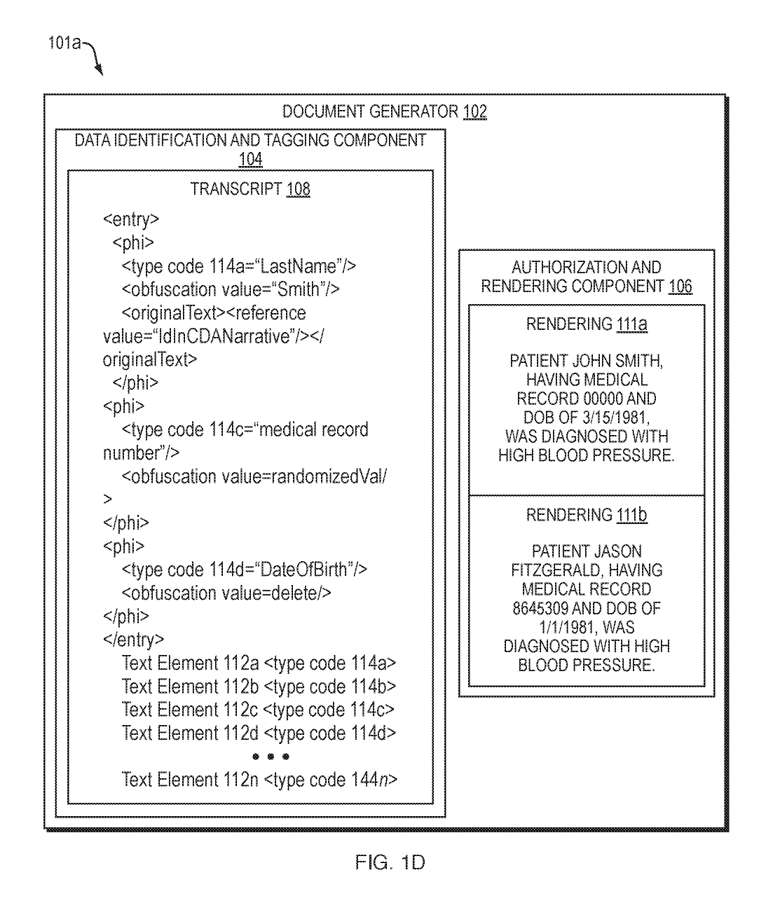

Referring to FIGS. 1A-D and 2, a method 200 for dynamic de-identification of a document includes generating a document including a tag associated with an element including protected health information, the tag including at least one instruction for rendering the element (210). The method includes identifying a level of authorization of a user requesting access to the generated document (220). The method includes rendering the document for display to the user according to the at least one instruction in the tag, based on the identified level of authorization (230).

The method 200 includes generating a document including a tag associated with an element including protected health information, the tag including at least one instruction for rendering the element (210). As will be understood by those of ordinary skill in the art, rendering produces output on an output device and may include providing visual output (e.g., textual output), audio output (e.g., text-to-speech or other audio output), or audio-visual output (e.g., video output). As shown in FIG. 1A, a document generator 102 may include a data identification and tagging component 104 that accesses a draft transcript 108 and may add the tag associated with the element including PHI to the draft transcript 108. The data identification and tagging component 104 may insert the tag into a transcription of an audio file.

The method 200 may include transcribing, by an automatic speech recognition engine, the audio file to generate the transcript 108. As shown in FIG. 1B, the document generator 102 may be in communication with a transcription system 130. In the embodiment shown in FIG. 1B, the transcription system 130 receives a spoken audio stream 120, generates the draft transcript 108 based on the spoken audio stream 120, and provides the draft transcript 108 to the data identification and tagging component 108 for tagging. In other embodiments, not shown, the document generator 102 includes the functionality of the transcription system 130 and receives the spoken audio stream 120 directly, generating the draft transcript 108 for tagging by the data identification and tagging component 104.

By way of example, the transcription system may be a transcription system as described in commonly-owned U.S. Pat. No. 7,584,103, entitled “Automated Extraction of Semantic Content and Generation of a Structured Document from Speech,” which is hereby incorporated by reference.

In one embodiment, as each document is generated (e.g., transcribed from speech), the data identification and tagging component 104 identifies any PHI in the document and tags each instance of PHI with metadata (such as, for example, through the use of XML tags). By way of example, the identification and tagging may occur as described in the above-referenced, commonly-owned U.S. Pat. No. 7,584,103. The data identification and tagging component 104 may analyze a transcribed document to identify the element and insert the tag into the transcribed document, based upon the analysis. In one embodiment, the data identification and tagging component 104 accesses a listing of identifiers generated based on law or regulation; for example, HIPAA regulations identify eighteen types of information that may potentially include PHI and the data identification and tagging component 104 may access a database listing the information types identified by HIPAA regulations. The metadata may indicate that the tagged element includes PHI. The metadata may indicate a type of PHI (e.g., full name, Social Security number, home address). The metadata may provide information about how to obfuscate the PHI when the document is rendered (displayed) to a user who does not have authority to view the PHI. In some embodiments, the data identification and tagging component 104 archives the finalized transcript 108, which includes the tags. For example, the document generator 102 may store the transcript 108 in a document database 110.

FIG. 1C is a block diagram depicting one embodiment of a draft transcript 108 in which the data identification and tagging component 104 has included in the draft transcript 108 at least one tag of at least one element containing PHI. In the embodiment shown in FIG. 1C, for an entry having a type code of “LastName,” the data identification and tagging component 104 has indicated that there is an obfuscation value of “Smith”—that is, when the finalized transcript 108 is rendered, any text element 112 associated with a type code 114a of “LastName” should display “Smith” instead of the original text element 112. As another example, the data identification and tagging component 104 may include in the draft transcript 108 a tag with an instruction to replace any text element 112 associated with a type code 114c with randomized values. As another example, the data identification and tagging component 104 may include in the draft transcript 108 a tag with an instruction to delete any text element 112 associated with a type code 114d. As indicated in FIG. 1C, a tag added to the transcript 108 may include a reference identifier indicating where in the transcript 108 PHI may be found. For example, the embodiment of FIG. 1C indicates that in the transcribed text contained within the transcript 108, a text element 112 associated with type code 114a is tagged with a reference value=“IdInCDANarrative” and when generating a rendering of the transcript 108 for a user unauthorized to view PHI, the system 100 may search for that reference value and replace any text at that location with an obfuscation value as specified by the tag. A rendering component 106 may, therefore, use the instructions within the tags to search for sections of the transcribed text that contain PHI and generate a rendering of the transcription in which the PHI is deleted, randomized, obfuscated, or otherwise de-identified. As will be understood by one of ordinary skill in the art, FIG. 1C depicts a stylized example of the contents of a transcript 108 and an actual draft transcript 108 may include much more varied or complex tags.

In some embodiments, the computing device 101a generates a transcript 108 from the spoken audio stream 120 and includes in this transcript 108 any tags needed to de-identify the transcript 108 during rendering. In one of these embodiments, therefore, a computing device 101b used by a user without authorization to access PHI does not receive any PHI; such an embodiment reduces a security risk that PHI will be located on an unauthorized client computer.

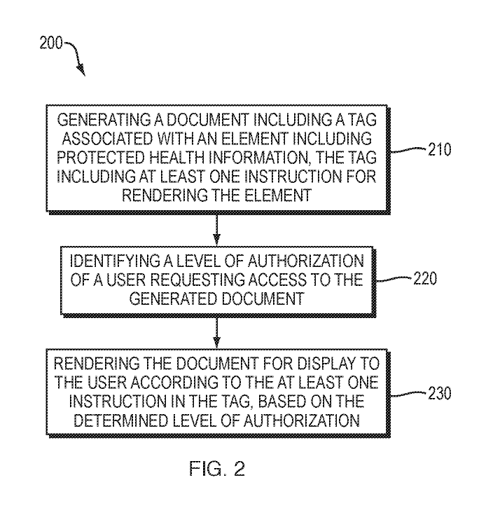

Referring back to FIG. 2, the method 200 includes identifying a level of authorization of a user requesting access to the generated document (220). An authorization and rendering component 106 may identify the level of authorization of the user requesting access to the generated document (e.g., the transcript 108). In one embodiment, the authorization and rendering component 106 identifies a type of portal a user associated with the computing device 101b used to transmit the request for access to the generated document (e.g., whether the user submitted the request from a portal for authorized users or from a portal for unauthorized users). In another embodiment, the authorization and rendering component 106 identifies a type of account a user associated with the computing device 101b used to log in to a system for transmitting the request for access to the generated document (e.g., whether the account, or a user name associated with the account, is authorized to access PHI). In still another embodiment, the authorization and rendering component 106 requests authorization credentials from the user of the computing device 101b to identify the level of authorization of the user.

The authorization and rendering component 106 may render an element in the generated document according to the at least one instruction in the tag, based on the identified level of authorization and without modifying the element in the document. The authorization and rendering component 106 may implement the at least one instruction in the tag to exclude the protected health information from the rendering of the document without removing the protected health information from the document. The authorization and rendering component 106 may implement the at least one instruction in the tag to obfuscate the protected health information in the rendering of the document without removing the protected health information from the document. The authorization and rendering component 106 may implement the at least one instruction in the tag to delete the protected health information in the rendering of the document, or otherwise omit the protected health information from the rendering of the document, without removing the protected health information from the document.

The authorization and rendering component 106 may determine that the user is authorized to view protected health information. In one embodiment, the authorization and rendering component 106 may implement the at least one instruction in the tag to include the protected health information in the rendering of the document. In another embodiment, the tags in transcript 108 only include instructions for de-identifying the transcript 108 before rendering the transcript 108 to an unauthorized user, and the authorization and rendering component 106 may render the transcript 108 in its entirety without applying any of the tags.

The authorization and rendering component 106 may determine that the user lacks authority to view protected health information. The authorization and rendering component 106 may then implement the at least one instruction in the tag to exclude the protected health information from the rending of the document. The authorization and rendering component 106 may implement the at least one instruction in the tag to obfuscate the protected health information in the rendering of the document. The authorization and rendering component 106 may implement the at least one instruction in the tag to delete the protected health information in the rendering of the document, or otherwise to omit the protected health information from the rendering of the document. The authorization and rendering component 106 may implement the at least one instruction in the tag to randomize the protected health information in the rendering of the document.

The method 200 includes rendering the document for display to the user according to the at least one instruction in the tag, based on the identified level of authorization (230).

In some embodiments, the authorization and rendering component 106 selects at least one instruction from a plurality of instructions included in the tag, based on the determined level of authorization. In one of these embodiments, the authorization and rendering component 106 renders the document according to the selected at least one instruction.

As shown in FIG. 1D, the authorization and rendering component 106 may generate a rendering 111a for an unauthorized user and may generate a rendering 111b for an authorized user. In some embodiments, the authorization and rendering component 106 transmits the rendering 111 to the computing device 101b. Although shown in FIG. 1D as a human-readable text document, the rendering 111 may also be a coded document providing instructions for how to render the document to a human user of the computing device 101b. For example, and without limitation, the rendering 111 may be an eXtensible Markup Language (XML) document.

As another example, consider the patient name “Jason Fitzgerald,” which is an example of PHI. The name “Jason Fitzgerald” may be tagged with information indicating that the name “Jason Fitzgerald” should instead be displayed to the user as “John Smith” (or another common name which does not identify the patient) if the user lacks authority to view the patient's real name. When the system displays the document to a user who lacks authority to view the patient's real name, the system may use the obfuscation information that is associated with each instance of PHI to display the obfuscated version of the PHI instead of the PHI itself. For example, the system may use the information indicated above to display “John Smith” instead of “Jason Fitzgerald” when rendering the document containing “Jason Fitzgerald” to a user who lacks authority to view the patient's real name.

Although the embodiments described above are directed to tagging elements within a single document, the methods and systems described herein may also provide functionality for tagging elements across a plurality of documents. In some embodiments, the data identification and tagging component 104 may determine that a plurality of transcripts 108a-n have at least one element in common; for example, and without limitation, the data identification and tagging component 104 may analyze a plurality of transcripts 108a-n and determine that the plurality of transcripts 108a-n are all related to a single patient. For example, the data identification and tagging component 104 may generate a first tagged, draft transcript 108 and then search a document database 110 to determine whether any previously archived transcripts have at least one element in common (e.g., list the same patient as is listed in the draft transcript). Based on the determination, the data identification and tagging component 104 may identify a type of obfuscation to be applied to a particular element in each of the plurality of transcripts 108a-n. As another example, each generated draft transcript 108 may be associated with one or more items of meta-data (for example, and without limitation, hospital identifier, facility identifier, facility name, patient name, patient identifier, date of birth, physician, name, physician identifier, or time of document generation). In such an example, the system may provide functionality for applying a hash function to at least one item of meta-data (e.g., and without limitation, hospital identifier, physician identifier and hospital identifier, hospital identifier and patient identifier, visit identifier and hospital identifier and patient identifier) to generate another identifier for the generated transcript 108; transcripts 108 having the same identifier may be obfuscated in a consistent manner. The system may also provide functionality for using patient and physician identifiers to uniquely select from a population of random names. For example, the system may provide functionality for applying a hash function to a patient identifier and a physician identifier (e.g., to a concatenation of the two identifiers) and use the output of the applied hash function to select a random name for use in obfuscation (e.g., by searching a data structure for the output of the applied hash function to identify a random name associated with the output in the data structure).

In one embodiment, consistently applying a particular type of obfuscation to each of the plurality of transcripts 108a-n. Such consistency in tagging may result in a consistent record (e.g., for a particular patient). Such consistency in tagging may result analysis of the plurality of transcripts 108a-n as a unit. By way of example, and without limitation, multiple records may be associated with a particular patient and may include PHI that could be obfuscated in a variety of ways; by determining that the records associated with that patient should be consistently obfuscated in one way in particular, the system enables improved analyses of the patient data than if the data was inconsistent.

The methods and systems described herein may also provide improvements to the process of searching a dataset that contains PHI. For example, if a user who lacks authority to view PHI performs a search for PHI (e.g., “show me all users with telephone numbers starting in 456”), then the system will not perform that search. More specifically, the system will not attempt to match a query against data that is marked as PHI in the dataset. Therefore, a search may be performed using a particular query, but the query may not be applied to every element in the dataset. More specifically, the query may be applied to non-PHI data elements (such as portions of documents) in the dataset, but not to PHI data elements in the data set. As a result, the search will execute the query and produce search results, but will exclude results that would have matched the query if the query were allowed to match against PHI data elements.

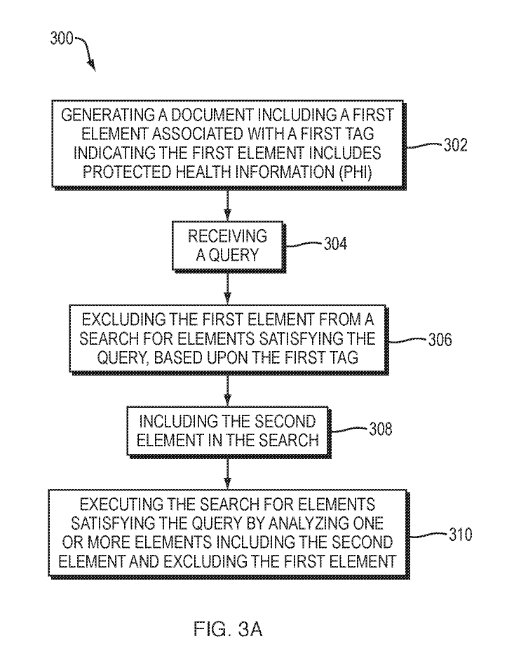

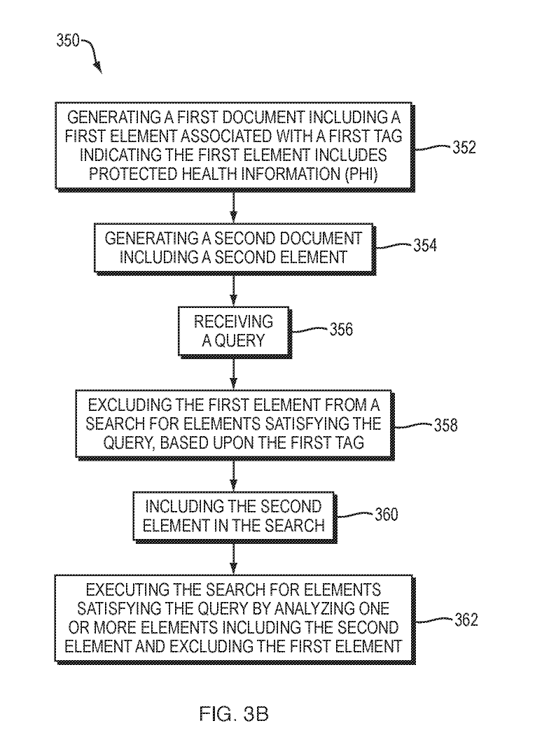

Referring now to FIG. 3A, a block diagram depicts one embodiment of a method 300 for searching elements of a document including at least one dynamically de-identified element. The method 300 includes generating a document including a first element and a second element, the first element associated with a first tag indicating the first element includes protected health information (PHI) (302). The method 300 includes receiving a query (304). The method 300 includes excluding the first element from a search for elements satisfying the query, based upon the first tag (306). The method 300 includes including the second element in the search (308). The method 300 includes executing the search for elements satisfying the query by analyzing one or more elements including the second element and excluding the first element (310).

The method 300 includes generating a document including a first element and a second element, the first element associated with a first tag indicating the first element includes protected health information (PHI) (302). The document generation may occur as described above in connection with FIGS. 1A-1D and 2.

The method 300 includes receiving a query (304). In one embodiment, the authorization and rendering component 106 receives the query from a computing device 101b. In another embodiment, a search component 140 receives the query from a computing device 101b.

The method 300 includes excluding the first element from a search for elements satisfying the query, based upon the first tag (306). In one embodiment, the search component 140 determines whether the document includes any tags. If so, the search component 140 identifies a type code included in the tag or tags and compares the type code to a type code of the query. If the two type codes are substantially similar, the search component 140 excludes any text elements in the transcript 108 from the search results.

The method 300 includes including the second element in the search (308). If there are no tags associated with the type code associated with the element, the search component 140 may include the element in the search. If the search component 140 determines that there are no tags embedded in the transcript 108, the search component 140 may include all elements of the transcript 108 in the search.

The method 300 includes executing the search for elements satisfying the query by analyzing one or more elements including the second element and excluding the first element (310).

Referring now to FIG. 3B, a block diagram depicts one embodiment of a method 350 for querying a plurality of documents including at least one dynamically de-identified document. The method 350 includes generating a first document including a first element associated with a first tag indicating the first element includes protected health information (PHI) (352). The method 350 includes generating a second document including a second element (354). The method 350 includes receiving a query (356). The method 350 includes excluding the first element from a search for elements satisfying the query, based upon the first tag (358). The method 350 includes including the second element in the search (360). The method 350 includes executing the search for elements satisfying the query by analyzing one or more elements including the second element and excluding the first element (362).

The method 350 includes generating a first document including a first element associated with a first tag indicating the first element includes protected health information (PHI) (352). The first document may be generated as described above in connection with FIGS. 1A-1D and 2.

The method 350 includes generating a second document including a second element (354). The second document may be generated as described above in connection with FIGS. 1A-1D and 2.

The method 350 includes receiving a query (356). The query may be received as described above in connection with FIG. 3A.

The method 350 includes excluding the first element from a search for elements satisfying the query, based upon the first tag (358). The exclusion may occur as described above in connection with FIG. 3A.

The method 350 includes including the second element in the search (360). The inclusion may occur as described above in connection with FIG. 3A.

The method 350 includes executing the search for elements satisfying the query by analyzing one or more elements including the second element and excluding the first element (362). The search may be executed as described above in connection with FIG. 3A.

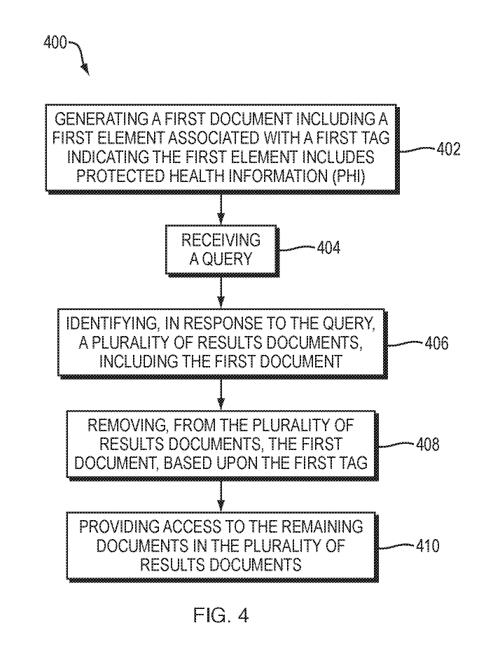

Referring now to FIG. 4, a block diagram depicts one embodiment of a method 350 for querying a plurality of documents including at least one dynamically de-identified document. The method 400 includes generating a first document including a first element associated with a first tag indicating the first element includes protected health information (PHI) (402). The method 400 includes receiving a query (404). The method 400 includes identifying, in response to the query, a plurality of results documents, including the first document (406). The method 400 includes removing, from the plurality of results documents, the first document, based upon the first tag (408). The method 400 includes providing access to the remaining documents in the plurality of results documents (410).

The method 400 includes generating a first document including a first element associated with a first tag indicating the first element includes protected health information (PHI) (402). The first document may be generated as described above in connection with FIGS. 1A-1D and 2.

The method 400 includes receiving a query (404). The query may be received as described above in connection with FIG. 3A.

The method 400 includes identifying, in response to the query, a plurality of results documents, including the first document (406). The method 400 may include receiving an identification of each of the plurality of documents from a third party search engine. Alternatively, the search component 140 may include a search engine with which to process queries.

The method 400 includes removing, from the plurality of results documents, the first document, based upon the first tag (408). The removal may occur as described above in connection with FIG. 3A. For example, the search component 140 may analyze each of the plurality of results documents to determine whether any of the documents include a tag similar to the first tag. Upon identifying such a document in the plurality of results documents, the search component 140 may remove the document.

The method 400 includes providing access to the remaining documents in the plurality of results documents (410). The search component 140 may provide copies of the remaining documents to a user of a computing device 101b from which the query originated. The search component 140 may provide an identification of the remaining documents to a user of a computing device 101b from which the query originated. The search component 140 may provide instructions for accessing each of the remaining documents to a user of a computing device 101b from which the query originated.

In other embodiments, instead of removing the first document from the plurality of results documents, the search component 140 may alter the first document based on the first tag. For example, instead of removing a document entirely, the search component 140 may determine that the tag allows distribution of the document if the PHI is obfuscated; the search component 140 may then direct the authorization and rendering component 106 to process the tag and provide access to the document including the obfuscated PHI.

Embodiments of the present invention have a variety of advantages. For example, the rendering instructions provided in the tags of the transcript 108 may allow a user who is not authorized to view PHI to view a document that is consistent and whole, in which nothing appears redacted because any redacted elements are either deleted or obfuscated in a way that gives consistency for analysis purposes. A single document may, therefore, include both PHI and non-PHI data (or, more generally, data to be de-identified and data not to be de-identified), as well as instructions for how to render the data in a de-identified manner.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present render documents on output devices, such as computer monitors and touchscreens. Only a computing device can perform such rendering.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method for dynamic de-identification of a document, the method performed by at least one computer processor executing computer program instructions stored on at least one non-transitory computer-readable medium, the method comprising:
generating a document including a tag associated with an element including protected health information, the tag including at least one instruction for rendering the element;
identifying a level of authorization of a user requesting access to the generated document;
rendering the document for display to the user according to the at least one instruction in the tag, based on the identified level of authorization.

2. The method of claim 1, wherein identifying further comprises identifying that the user is authorized to view protected health information.

3. The method of claim 2, wherein rendering further comprises implementing the at least one instruction in the tag to include the protected health information in the rendering of the document.

4. The method of claim 1, wherein identifying further comprises identifying that the user lacks authority to view protected health information.

5. The method of claim 4, wherein rendering further comprises implementing the at least one instruction in the tag to exclude the protected health information from the rendering of the document.

6. The method of claim 4, wherein rendering further comprises implementing the at least one instruction in the tag to obfuscate the protected health information in the rendering of the document.

7. The method of claim 4, wherein rendering further comprises implementing the at least one instruction in the tag to randomize the protected health information in the rendering of the document.

8. The method of claim 1, wherein rendering further comprises rendering the element according to the at least one instruction in the tag, based on the identified level of authorization.

9. The method of claim 1, wherein rendering further comprises rendering the element according to the at least one instruction in the tag, based on the identified level of authorization and without modifying the element in the document.

10. The method of claim 9, wherein rendering further comprises implementing the at least one instruction in the tag to exclude the protected health information from the rendering of the document without removing the protected health information from the document.

11. The method of claim 9, wherein rendering further comprises implementing the at least one instruction in the tag to obfuscate the protected health information in the rendering of the document without removing the protected health information from the document.

12. The method of claim 1, wherein generating further comprises inserting the tag into a transcription of an audio file.

13. The method of claim 12 further comprising transcribing, by an automatic speech recognition engine, the audio file to generate the transcription.

14. The method of claim 1, wherein generating further comprises:
analyzing a transcribed document to identify the element; and
inserting the tag into the transcribed document, based upon the analysis.

15. A system comprising at least one non-transitory computer-readable medium storing computer program instructions executable by at least one computer processor to perform a method for dynamic de-identification of a document, the method comprising:
generating a document including a tag associated with an element including protected health information, the tag including at least one instruction for rendering the element;
identifying a level of authorization of a user requesting access to the generated document;
rendering the document for display to the user according to the at least one instruction in the tag, based on the identified level of authorization.

16. The system of claim 15, wherein identifying further comprises identifying that the user is authorized to view protected health information.

17. The system of claim 16, wherein rendering further comprises implementing the at least one instruction in the tag to include the protected health information in the rendering of the document.

18. The system of claim 15, wherein identifying further comprises identifying that the user lacks authority to view protected health information.

19. The system of claim 18, wherein rendering further comprises implementing the at least one instruction in the tag to exclude the protected health information from the rendering of the document.

20. The system of claim 18, wherein rendering further comprises implementing the at least one instruction in the tag to obfuscate the protected health information in the rendering of the document.

21. The system of claim 18, wherein rendering further comprises implementing the at least one instruction in the tag to randomize the protected health information in the rendering of the document.

22. The system of claim 15, wherein rendering further comprises rendering the element according to the at least one instruction in the tag, based on the identified level of authorization.

23. The system of claim 15, wherein rendering further comprises rendering the element according to the at least one instruction in the tag, based on the identified level of authorization and without modifying the element in the document.

24. The system of claim 23, wherein rendering further comprises implementing the at least one instruction in the tag to exclude the protected health information from the rendering of the document without removing the protected health information from the document.

25. The system of claim 23, wherein rendering further comprises implementing the at least one instruction in the tag to obfuscate the protected health information in the rendering of the document without removing the protected health information from the document.

26. The system of claim 15, wherein generating further comprises inserting the tag into a transcription of an audio file.

27. The system of claim 26 further comprising transcribing, by an automatic speech recognition engine, the audio file to generate the transcription.

28. The system of claim 15, wherein generating further comprises:
analyzing a transcribed document to identify the element; and
inserting the tag into the transcribed document, based upon the analysis.

29. A method for searching elements of a document including at least one dynamically de-identified element, the method performed by at least one computer processor executing computer program instructions stored on at least one non-transitory computer-readable medium, the method comprising:
generating a document including a first element associated with a first tag indicating the first element includes protected health information (PHI);
receiving a query;
excluding the first element from a search for elements satisfying the query, based upon the first tag;
including the second element in the search; and
executing the search for elements satisfying the query by analyzing one or more elements including the second element and excluding the first element.

30. A system comprising at least one non-transitory computer-readable medium storing computer program instructions executable by at least one computer processor to perform a method for searching elements of a document including at least one dynamically de-identified element, the method comprising:
generating a document including a first element associated with a first tag indicating the first element includes protected health information (PHI);
receiving a query;
excluding the first element from a search for elements satisfying the query, based upon the first tag;
including the second element in the search; and
executing the search for elements satisfying the query by analyzing one or more elements including the second element and excluding the first element.

31. A method for querying a plurality of documents including at least one dynamically de-identified document, the method performed by at least one computer processor executing computer program instructions stored on at least one non-transitory computer-readable medium, the method comprising:
generating a first document including a first element associated with a first tag indicating the first element includes protected health information (PHI);
generating a second document including a second element;
receiving a query;
excluding the first element from a search for elements satisfying the query, based upon the first tag;
including the second element in the search; and
executing the search for elements satisfying the query by analyzing one or more elements including the second element and excluding the first element.

32. A system comprising at least one non-transitory computer-readable medium storing computer program instructions executable by at least one computer processor to perform a method for querying a plurality of documents including at least one dynamically de-identified document, the method comprising:
generating a first document including a first element associated with a first tag indicating the first element includes protected health information (PHI);
generating a second document including a second element;
receiving a query;
excluding the first element from a search for elements satisfying the query, based upon the first tag;
including the second element in the search; and
executing the search for elements satisfying the query by analyzing one or more elements including the second element and excluding the first element.
